(19) United States
(12) Patent Application Publication
(10) Pub. No.: US 2026/0054748 A1
(43) Pub. Date: Feb. 26, 2026

(54) TRACK BASED MAP ANOMALY DETECTION

(71) Applicant: Aurora Operations, Inc., Pittsburgh, PA (US)

(72) Inventors: Alexander Feldman, San Francisco, CA (US); John Howard, San Francisco, CA (US)

(21) Appl. No.: 18/810,307

(22) Filed: Aug. 20, 2024

(51) Int. Cl. B60W 60/00

(52) U.S. Cl. CPC B60W 60/0015; B60W 2552/10; B60W 2554/402; B60W 2554/4041; B60W 2554/4042; B60W 2556/45; B60W 2720/10

(57) ABSTRACT

An autonomous vehicle control system and method may detect the tracks of non-ego vehicles in a roadway and use those tracks to detect roadway closure events ahead of an autonomous vehicle based at least in part on determinations that those non-ego vehicle tracks leave the roadway. By doing so, map anomalies may be identified and corrective actions may be automatically initiated prior to the autonomous vehicle arriving at the location where the non-ego vehicle tracks leave the roadway.

### BACKGROUND

As computing and vehicular technologies continue to evolve, autonomy-related features have become more powerful and widely available, and capable of controlling vehicles in a wider variety of circumstances. For automobiles, for example, the automotive industry has generally adopted SAE International standard J3016, which designates 6 levels of autonomy. A vehicle with no autonomy is designated as Level 0, and with Level 1 autonomy, a vehicle controls steering or speed (but not both), leaving the operator to perform most vehicle functions. With Level 2 autonomy, a vehicle is capable of controlling steering, speed and braking in limited circumstances (e.g., while traveling along a highway), but the operator is still required to remain alert and be ready to take over operation at any instant, as well as to handle any maneuvers such as changing lanes or turning. Starting with Level 3 autonomy, a vehicle can manage most operating variables, including monitoring the surrounding environment, but an operator is still required to remain alert and take over whenever a scenario the vehicle is unable to handle is encountered. Level 4 autonomy provides an ability to operate without operator input, but only in specific conditions such as only certain types of roads (e.g., highways) or only certain geographical areas (e.g., specific cities for which adequate map data exists). Finally, Level 5 autonomy represents a level of autonomy where a vehicle is capable of operating free of operator control under any circumstances where a human operator could also operate.

The fundamental challenges of any autonomy-related technology relate to collecting and interpreting information about a vehicle's surrounding environment, along with making and implementing decisions to appropriately control the vehicle given the current environment within which the vehicle is operating. Therefore, continuing efforts are being made to improve each of these aspects, and by doing so, autonomous vehicles increasingly are able to reliably handle a wider variety of situations and accommodate both expected and unexpected conditions within an environment.

A particular challenge, for example, results from the inherently dynamic environment within which autonomous vehicles are expected to operate. Many autonomous vehicles, for example, rely principally on high resolution (high quality) digital maps that represent the various static objects in an environment, e.g., including real word objects or elements such as roads, curbs, buildings, trees, signs, etc., as well as logical elements such as lanes, boundaries, etc., when generating trajectories to be followed. Other autonomous vehicles rely principally on perception systems (e.g., incorporating cameras, radar and/or LIDAR sensors) to sense their surroundings and generate trajectories accordingly, and generally with little or no reference to any digital map. Where high quality digital maps are used, attempts are generally made to maintain and update the maps to accommodate changes that occur in the environment; however, the overhead associated with verifying and distributing map data to a fleet of autonomous vehicles can be substantial. Furthermore, even with rapid updates, changes may nonetheless arise suddenly in an environment and not be reflected in the map data used by autonomous vehicles operating in the environment.

Moreover, while in some instances an autonomous vehicle's perception system may be used to detect changed circumstances in an environment (e.g., the presence of new construction elements such as traffic cones and/or barrels), the detection range of such a system is generally limited, and can be occluded as a result of the presence of other vehicles nearby, such that the amount of time that an autonomous vehicle may be given to react to some changed circumstances may be undesirably short. As such, a continuing need exists in the art for a manner of improving an autonomous vehicle's awareness of the relevant objects and elements in its environment.

It has been found, in particular, that construction areas can present challenges when generating autonomous vehicle trajectories, regardless of whether high quality digital maps are used. Even in non-constructions areas, various actual and logical boundaries may exist that constrain where an autonomous vehicle may travel, including, for example, painted or taped lines on the roadway; the physical edges of the roadway; and various physical barriers such as concrete barriers, guardrails, etc. In construction areas, these existing boundaries may be supplemented by additional boundaries such as repainted lines for temporary traffic diversions (which in some instances may overlap existing lines), spaced apart construction elements such as barrels or traffic cones that appear as distinct objects to the perception system, and construction elements such as jersey barriers that can be difficult to classify due to difficulties in determining object boundaries.

In some instances, traffic may even be diverted off of the mapped edges of a roadway onto new or temporary pavement or into lanes that were previously used for oncoming traffic. Further, traffic may be diverted onto a connecting road in some instances, e.g., as a result of temporary construction or a crash. If such anomalies are not represented in a digital map, first encounters with such anomalies can present particular challenges for an autonomous vehicle, because some corrective action generally must be taken to account for such anomalies. Therefore, a continuing need exists in the art for improved manners of detecting, managing, interpreting, and reacting to the various scenarios that an autonomous vehicle may encounter during operation.

### SUMMARY

The present disclosure is related in part to and autonomous vehicle control system and method that detect the tracks of non-ego vehicles in a roadway (i.e., vehicles other than the autonomous vehicle within which the autonomous vehicle control system is implemented) and use those tracks to detect roadway closure events ahead of an autonomous vehicle based at least in part on determinations that those non-ego vehicle tracks leave the roadway. By doing so, corrective actions may be automatically initiated prior to the autonomous vehicle arriving at the location where the non-ego vehicle tracks leave the roadway.

Therefore, consistent with one aspect of the invention, a method of controlling an autonomous vehicle may include receiving observation data collected from a geographical area by one or more sensors of the autonomous vehicle while the autonomous vehicle operates on a roadway in the geographical area, where the received observation data includes non-ego vehicle observation data for a plurality of non-ego vehicles operating ahead of the autonomous vehicle on the roadway and sensed by the one or more sensors of the autonomous vehicle, generating a plurality of non-ego vehicle tracks using the non-ego vehicle observation data, detecting a roadway closure event ahead of the autonomous vehicle on the roadway using the plurality of non-ego vehicle tracks, including determining that one or more of the plurality of non-ego vehicle tracks leave the roadway, and in response to detecting the roadway closure event, initiating a corrective action in the autonomous vehicle prior to the autonomous vehicle arriving at a location at which the one or more non-ego vehicle tracks leave the roadway.

In some implementations, the roadway closure event is a construction event associated with routing traffic off of a mapped region of the roadway. In addition, in some implementations, the construction event is associated with routing traffic off of the mapped region of the roadway and onto an unmapped road surface formed adjacent to the mapped region of the roadway Also, in some implementations, the roadway closure event is a construction event associated with routing traffic onto one or more opposite direction lanes defined in a mapped region of the roadway. Moreover, in some implementations, the roadway closure event is a total roadway closure event associated with routing traffic off of the roadway and onto a connecting road or exit ramp.

Further, in some implementations, the corrective action includes decreasing a speed of the autonomous vehicle, initiating a session with a remote teleassist system, initiating a lane change to locate the autonomous vehicle adjacent to a shoulder of the roadway, initiating a follow-the-leader mode for the autonomous vehicle, or initiating a safety stop operation for the autonomous vehicle. Some implementations may also include detecting, from the observation data, one or more signs, construction elements, construction vehicles, and/or emergency vehicles, and detecting the roadway closure event ahead of the autonomous vehicle on the roadway further uses the detected one or more signs, construction elements, construction vehicles, and/or emergency vehicles.

Some implementations may further include filtering the plurality of non-ego vehicle tracks based on one or more of a speed, a location, a duration, a length, and a confidence associated with the plurality of non-ego vehicle tracks. Further, in some implementations, determining that the one or more of the plurality of non-ego vehicle tracks leave the roadway includes determining that trajectories of the one or more non-ego vehicle tracks intersect with mapped edges of the roadway.

In some implementations, determining that the one or more non-ego vehicle tracks leave the roadway includes in a first, less intensive computational analysis step, determining that a first non-ego vehicle track of the one or more non-ego vehicle tracks intersects with a mapped edge of the roadway, and after determining that the trajectory of the first non-ego vehicle track intersects with the mapped edge of the roadway, performing a second, more intensive computational analysis step on the first non-ego vehicle track to confirm that the first non-ego vehicle track leaves the roadway.

Also, in some implementations, determining that the one or more non-ego vehicle tracks leave the roadway includes determining that a non-ego vehicle track leaves the roadway by more than a boundary detection range ahead of the autonomous vehicle.

Consistent with another aspect of the invention, an autonomous vehicle control system for an autonomous vehicle may include one or more processors and memory storing instructions that, when executed by the one or more processors, cause the autonomous vehicle control system to receive observation data collected from a geographical area by one or more sensors of the autonomous vehicle while the autonomous vehicle operates on a roadway in the geographical area, the received observation data includes non-ego vehicle observation data for a plurality of non-ego vehicles operating ahead of the autonomous vehicle on the roadway and sensed by the one or more sensors of the autonomous vehicle, generate a plurality of non-ego vehicle tracks using the non-ego vehicle observation data, detect a roadway closure event ahead of the autonomous vehicle on the roadway using the plurality of non-ego vehicle tracks, including determining that one or more of the plurality of non-ego vehicle tracks leave the roadway, and in response to detecting the roadway closure event, initiate a corrective action in the autonomous vehicle prior to the autonomous vehicle arriving at a location at which the one or more non-ego vehicle tracks leave the roadway.

In some implementations, the roadway closure event is a construction event associated with routing traffic off of a mapped region of the roadway, a construction event associated with routing traffic onto one or more opposite direction lanes defined in a mapped region of the roadway, or a total roadway closure event associated with routing traffic off of the roadway and onto a connecting road or exit ramp. Further, in some implementations, the corrective action includes decreasing a speed of the autonomous vehicle, initiating a session with a remote teleassist system, initiating a lane change to locate the autonomous vehicle adjacent to a shoulder of the roadway, initiating a follow-the-leader mode for the autonomous vehicle, or initiating a safety stop operation for the autonomous vehicle.

In some implementations, the one or more processors are further configured to detect, from the observation data, one or more signs, construction elements, construction vehicles, and/or emergency vehicles, and to detect the roadway closure event ahead of the autonomous vehicle on the roadway by further using the detected one or more signs, construction elements, construction vehicles, and/or emergency vehicles. Further, in some implementations, the one or more processors are further configured to filter the plurality of non-ego vehicle tracks based on one or more of a speed, a location, a duration, a length, and a confidence associated with the plurality of non-ego vehicle tracks.

Also, in some implementations, the one or more processors are configured to determine that one or more of the plurality of non-ego vehicle tracks leave the roadway by determining that trajectories of the one or more non-ego vehicle tracks intersect with mapped edges of the roadway. In addition, in some implementations, the one or more processors are configured to determine that the one or more non-ego vehicle tracks leave the roadway by, in a first, less intensive computational analysis step, determining that a first non-ego vehicle track of the one or more non-ego vehicle tracks intersects with a mapped edge of the roadway, and after determining that the trajectory of the first non-ego vehicle track intersects with the mapped edge of the roadway, performing a second, more intensive computational analysis step on the first non-ego vehicle track to confirm that the first non-ego vehicle track leaves the roadway.

In some implementations, the one or more processors are configured to determine that the one or more non-ego vehicle tracks leave the roadway by determining that a non-ego vehicle track leaves the roadway by more than a boundary detection range ahead of the autonomous vehicle.

Consistent with another aspect of the invention, a method of operating an autonomous vehicle may include receiving observation data collected from a geographical area by one or more sensors of the autonomous vehicle while the autonomous vehicle operates on a roadway in the geographical area, where the received observation data includes non-ego vehicle observation data for a plurality of non-ego vehicles operating ahead of the autonomous vehicle on the roadway and sensed by the one or more sensors of the autonomous vehicle, generating a plurality of non-ego vehicle tracks using the non-ego vehicle observation data, detecting a roadway closure event ahead of the autonomous vehicle on the roadway using the plurality of non-ego vehicle tracks, including determining that one or more of the plurality of non-ego vehicle tracks leave the roadway, and in response to detecting the roadway closure event, initiating a corrective action in the autonomous vehicle prior to the autonomous vehicle arriving at a location at which the one or more non-ego vehicle track leaves the roadway.

Some implementations may also include an autonomous vehicle and/or a system that is remotely located from an autonomous vehicle and includes one or more processors that are configured to perform various of the operations described above. Some implementations may also include an autonomous vehicle control system including one or more processors, a computer readable storage medium such as a memory, and computer instructions resident in the computer readable storage medium or memory and executable by the one or more processors to perform various of the methods described above. Still other implementations may include a non-transitory computer readable storage medium that stores computer instructions executable by one or more processors to perform various of the methods described above. Yet other implementations may include a method of operating any of the autonomous vehicles or autonomous vehicle control systems described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example hardware and software environment for an autonomous vehicle.

FIG. 2 is a block diagram illustrating a system for controlling an autonomous vehicle.

FIG. 3 is a block diagram illustrating an example perception system incorporating a multi-head machine learning model consistent with some implementations.

FIG. 4 is a flowchart illustrating an example operational sequence for detecting map anomalies consistent with some implementations.

FIG. 5 is a flowchart illustrating an example operational sequence for detecting non-ego vehicle tracks leaving a mapped roadway consistent with some implementations.

FIG. 6 is a flowchart illustrating an example operational sequence for initiating a corrective action consistent with some implementations.

FIG. 7 illustrates a roadway with an example road closure event in which traffic is diverted onto a connecting road.

FIG. 8 illustrates a roadway with an example road closure event in which traffic is diverted onto an exit ramp.

FIG. 9 illustrates a roadway with an example road closure event in which some traffic is diverted onto an unmapped road surface, and some traffic is diverted into an opposite direction lane.

### DETAILED DESCRIPTION

The various implementations discussed hereinafter are generally directed in part to detecting a road closure event resulting from vehicle traffic leaving a mapped roadway, in part using detected tracks of one or more non-ego vehicles in the vicinity of an autonomous vehicle. Prior to a discussion of these implementations, however, an example hardware and software environment within which the various techniques disclosed herein may be implemented will be discussed.

### Hardware and Software Environment

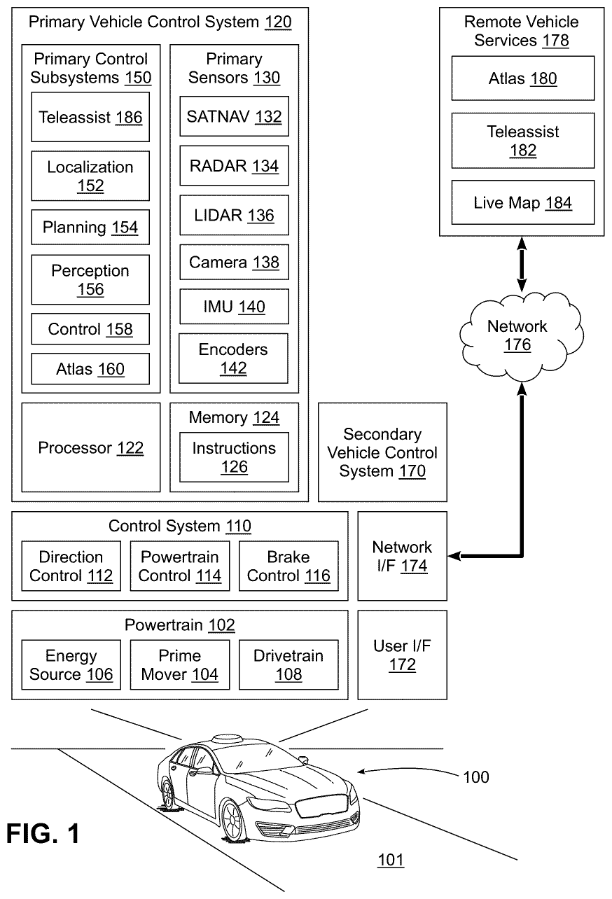

Turning to the Drawings, wherein like numbers denote like parts throughout the several views, FIG. 1 illustrates an example autonomous vehicle 100 within which the various techniques disclosed herein may be implemented. Vehicle 100, for example, is shown driving on a road 101, and vehicle 100 may include a powertrain 102 including a prime mover 104 powered by an energy source 106 and capable of providing power to a drivetrain 108, as well as a control system 110 including a direction control 112, a powertrain control 114 and brake control 116. Vehicle 100 may be implemented as any number of different types of vehicles, including vehicles capable of transporting people and/or cargo, and capable of traveling by land, by sea, by air, underground, undersea and/or in space, and it will be appreciated that the aforementioned components 102-116 can vary widely based upon the type of vehicle within which these components are utilized. In addition, vehicle 100 may be considered to be an “ego vehicle” from the perspective of its operation and control, with other vehicles in the surrounding environment (which may be autonomous vehicles or non-autonomous vehicles) considered to be “non-ego vehicles” relative to the autonomous/ego vehicle.

The implementations discussed hereinafter, for example, will focus on a wheeled land vehicle such as a car, van, truck, bus, etc. In such implementations, the prime mover 104 may include one or more electric motors and/or an internal combustion engine (among others), while energy source 106 may include a fuel system (e.g., providing gasoline, diesel, hydrogen, etc.), a battery system, solar panels or other renewable energy source, a fuel cell system, etc., and drivetrain 108 may include wheels and/or tires along with a transmission and/or any other mechanical drive components suitable for converting the output of prime mover 104 into vehicular motion, as well as one or more brakes configured to controllably stop or slow the vehicle and direction or steering components suitable for controlling the trajectory of the vehicle (e.g., a rack and pinion steering linkage enabling one or more wheels of vehicle 100 to pivot about a generally vertical axis to vary an angle of the rotational planes of the wheels relative to the longitudinal axis of the vehicle). In some implementations, combinations of powertrains and energy sources may be used, e.g., in the case of electric/gas hybrid vehicles, and in some instances multiple electric motors (e.g., dedicated to individual wheels or axles) may be used as a prime mover. In the case of a hydrogen fuel cell implementation, the prime mover may include one or more electric motors and the energy source may include a fuel cell system powered by hydrogen fuel.

Direction control 112 may include one or more actuators and/or sensors for controlling and receiving feedback from the direction or steering components to enable the vehicle to follow a desired trajectory. Powertrain control 114 may be configured to control the output of powertrain 102, e.g., to control the output power of prime mover 104, to control a gear of a transmission in drivetrain 108, etc., thereby controlling a speed and/or direction of the vehicle. Brake control 116 may be configured to control one or more brakes that slow or stop vehicle 100, e.g., disk or drum brakes coupled to the wheels of the vehicle.

Other vehicle types, including but not limited to off-road vehicles, all-terrain or tracked vehicles, construction equipment, etc., will necessarily utilize different powertrains, drivetrains, energy sources, direction controls, powertrain controls and brake controls, as will be appreciated by those of ordinary skill having the benefit of the instant disclosure. Moreover, in some implementations some of the components may be combined, e.g., where directional control of a vehicle is primarily handled by varying an output of one or more prime movers. Therefore, the invention is not limited to the particular application of the herein-described techniques in an autonomous wheeled land vehicle.

In the illustrated implementation, autonomous control over vehicle 100 (which may include various degrees of autonomy as well as selectively autonomous functionality) is primarily implemented in a primary vehicle control system 120, which may include one or more processors 122 and one or more memories 124, with each processor 122 configured to execute program code instructions 126 stored in a memory 124.

A primary sensor system 130 may include various sensors suitable for collecting information from a vehicle's surrounding environment for use in controlling the operation of the vehicle. For example, a satellite navigation (SATNAV) sensor 132, e.g., compatible with any of various satellite navigation systems such as GPS, GLONASS, Galileo, Compass, etc., may be used to determine the location of the vehicle on the Earth using satellite signals. Radio Detection And Ranging (RADAR) and Light Detection and Ranging (LIDAR) sensors 134, 136, as well as one or more digital cameras 138 (which may include various types of image capture devices capable of capturing still and/or video imagery), may be used to sense stationary and moving objects within the immediate vicinity of a vehicle. An inertial measurement unit (IMU) 140 may include multiple gyroscopes and accelerometers capable of detection linear and rotational motion of a vehicle in three directions, while one or more wheel encoders 142 may be used to monitor the rotation of one or more wheels of vehicle 100.

The outputs of sensors 132-142 may be provided to a set of primary control subsystems 150, including, a localization subsystem 152, a planning subsystem 154, a perception subsystem 156, and a control subsystem 158. Localization subsystem 152 is principally responsible for precisely determining the location and orientation (also sometimes referred to as “pose”, which in some instances may also include one or more velocities and/or accelerations) of vehicle 100 within its surrounding environment, and generally within some frame of reference. Planning subsystem 154 is principally responsible for planning a trajectory or path of motion for vehicle 100 over some timeframe given a desired destination as well as the static and moving objects within the environment, while perception subsystem 156 is principally responsible for detecting, tracking and/or identifying elements within the environment surrounding vehicle 100. Control subsystem 158 is principally responsible for generating suitable control signals for controlling the various controls in control system 110 in order to implement the planned trajectory or path of the vehicle. Any or all of localization subsystem 152, planning subsystem 154, perception subsystem 156, and control subsystem 158 may have associated data that is generated and/or utilized in connection with the operation thereof, and that which may be communicated to a teleassist system in some implementations.

In addition, an atlas or map subsystem 160 may be provided in the illustrated implementations to describe the elements within an environment and the relationships therebetween. Atlas subsystem 160 may be accessed by each of the localization, planning and perception subsystems 152-156 to obtain various information about the environment for use in performing their respective functions. Atlas subsystem 160 may be used to provide map data to the autonomous vehicle control system, which may be used for various purposes in an autonomous vehicle, including for localization, planning, and perception, among other purposes. Map data may be used, for example, to lay out or place elements within a particular geographical area, including, for example, elements that represent real world objects such as roadways, boundaries (e.g., barriers, lane dividers, medians, etc.), buildings, traffic devices (e.g., traffic or road signs, lights, etc.), as well as elements that are more logical or virtual in nature, e.g., elements that represent valid pathways a vehicle may take within an environment, “virtual” boundaries such as lane markings, or elements that represent logical collections or sets of other elements. Map data may also include data that characterizes or otherwise describes elements in an environment (e.g., data describing the geometry, dimensions, shape, etc. of objects), or data that describes the type, function, operation, purpose, etc., of elements in an environment (e.g., speed limits, lane restrictions, traffic device operations or logic, etc.). In some implementations, atlas subsystem 160 may provide map data in a format in which the positions of at least some of the elements in a geographical area are defined principally based upon relative positioning between elements rather than any absolute positioning within a global coordinate system. It will be appreciated, however, that other atlas or map systems suitable for maintaining map data for use by autonomous vehicles may be used in other implementations, including systems based upon absolute positioning. Furthermore, it will be appreciated that at least some of the map data that is generated and/or utilized by atlas subsystem 160 may be communicated to a teleassist system in some implementations.

It will be appreciated that the collection of components illustrated in FIG. 1 for primary vehicle control system 120 is merely exemplary in nature. Individual sensors may be omitted in some implementations, multiple sensors of the types illustrated in FIG. 1 may be used for redundancy and/or to cover different regions around a vehicle, and other types of sensors may be used. Likewise, different types and/or combinations of control subsystems may be used in other implementations. Further, while subsystems 152-160 are illustrated as being separate from processors 122 and memory 124, it will be appreciated that in some implementations, some or all of the functionality of a subsystem 152-160 may be implemented with program code instructions 126 resident in one or more memories 124 and executed by one or more processors 122, and that these subsystems 152-160 may in some instances be implemented using the same processors and/or memory. Subsystems in some implementations may be implemented at least in part using various dedicated circuit logic, various processors, various field-programmable gate arrays (“FPGA”), various application-specific integrated circuits (“ASIC”), various real time controllers, and the like, and as noted above, multiple subsystems may utilize common circuitry, processors, sensors and/or other components. Further, the various components in primary vehicle control system 120 may be networked in various manners.

In some implementations, vehicle 100 may also include a secondary vehicle control system 170, which may be used as a redundant or backup control system for vehicle 100. In some implementations, secondary vehicle control system 170 may be capable of fully operating autonomous vehicle 100 in the event of an adverse event in primary vehicle control system 120, while in other implementations, secondary vehicle control system 170 may only have limited functionality, e.g., to perform a controlled stop of vehicle 100 in response to an adverse event detected in primary vehicle control system 120. In still other implementations, secondary vehicle control system 170 may be omitted.

In general, an innumerable number of different architectures, including various combinations of software, hardware, circuit logic, sensors, networks, etc. may be used to implement the various components illustrated in FIG. 1. Each processor may be implemented, for example, as a microprocessor and each memory may represent the random access memory (RAM) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in vehicle 100, e.g., any cache memory in a processor, as well as any storage capacity used as a virtual memory, e.g., as stored on a mass storage device or on another computer or controller. One or more processors illustrated in FIG. 1, or entirely separate processors, may be used to implement additional functionality in vehicle 100 outside of the purposes of autonomous control, e.g., to control entertainment systems, to operate doors, lights, convenience features, etc.

In addition, for additional storage, vehicle 100 may also include one or more mass storage devices, e.g., a floppy or other removable disk drive, a hard disk drive, a direct access storage device (DASD), an optical drive (e.g., a CD drive, a DVD drive, etc.), a solid state storage drive (SSD), network attached storage, a storage area network, and/or a tape drive, among others. Furthermore, vehicle 100 may include a user interface 172 to enable vehicle 100 to receive a number of inputs from and generate outputs for a user or operator, e.g., one or more displays, touchscreens, voice and/or gesture interfaces, buttons and other tactile controls, etc. Otherwise, user input may be received via another computer or electronic device, e.g., via an app on a mobile device or via a web interface, e.g., from a remote operator.

Moreover, vehicle 100 may include one or more network interfaces, e.g., network interface 174, suitable for communicating with one or more networks 176 (e.g., a LAN, a WAN, a wireless network, and/or the Internet, among others) to permit the communication of information with other vehicles, computers and/or electronic devices, including, for example, a central service, such as a cloud service, from which vehicle 100 receives environmental and other data for use in autonomous control thereof. In the illustrated implementations, for example, vehicle 100 may be in communication with various cloud-based remote vehicle services 178 including, at least for the purposes of implementing various functions described herein, an atlas or map service or system 180, a teleassist service or system 182, and a live map service or system 184. Atlas or map service or system 180 may be used, for example, to maintain a global repository describing one or more geographical regions of the world, as well as to deploy portions of the global repository to one or more autonomous vehicles, to update the global repository based upon information received from one or more autonomous vehicles, and to otherwise manage the global repository. Teleassist service or system 182 may be used, for example, to provide teleassist support to vehicle 100, e.g., through communication with a teleassist subsystem 186 resident in primary vehicle control system 120, as will be discussed in greater detail below. Live map service or system 184 may be used to propagate various observations collected by one or more autonomous vehicles to effectively supplement the global repository maintained by atlas or map service or system 180. The terms “service” and “system” are generally used interchangeably herein, and generally refer to any computer functionality capable of receiving data from, and providing data to, an autonomous vehicle. In many instances, these services or systems may be considered to be remote services or systems insofar as they are generally external to an autonomous vehicle and in communication therewith.

Each processor illustrated in FIG. 1, as well as various additional controllers and subsystems disclosed herein, generally operates under the control of an operating system and executes or otherwise relies upon various computer software applications, components, programs, objects, modules, data structures, etc., as will be described in greater detail below. Moreover, various applications, components, programs, objects, modules, etc. may also execute on one or more processors in another computer coupled to vehicle 100 via network, e.g., in a distributed, cloud-based, or client-server computing environment, whereby the processing required to implement the functions of a computer program may be allocated to multiple computers and/or services over a network. Further, in some implementations data recorded or collected by a vehicle may be manually retrieved and uploaded to another computer or service for analysis.

In general, the routines executed to implement the various implementations described herein, whether implemented as part of an operating system or a specific application, component, program, object, module, machine learning model, or sequence of instructions, or even a subset thereof, will be referred to herein as “program code. ” Program code typically comprises one or more instructions that are resident at various times in various memory and storage devices, and that, when read and executed by one or more processors, perform the steps necessary to execute steps or elements embodying the various aspects of the invention. Moreover, while the invention has and hereinafter will be described in the context of fully functioning computers and systems, it will be appreciated that the various implementations described herein are capable of being distributed as a program product in a variety of forms, and that the invention applies equally regardless of the particular type of computer readable media used to actually carry out the distribution. Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.), among others.

In addition, various program code described hereinafter may be identified based upon the application within which it is implemented in a specific implementation. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

### Autonomous Vehicle Control System With Track Based Map Anomaly Detection

As noted above, a particular challenge associated with the operation of autonomous vehicles results from the inherently dynamic environment within which autonomous vehicles are expected to operate. Many autonomous vehicles, for example, rely principally on high resolution digital maps that represent the various static objects in an environment, e.g., including real word objects or elements such as roads, curbs, buildings, trees, signs, etc., as well as logical elements such as lanes, boundaries, etc., when generating trajectories to be followed. Other autonomous vehicles rely principally on perception systems (e.g., incorporating cameras, radar and/or LIDAR sensors) to sense their surroundings and generate trajectories accordingly, and generally with little or no reference to any digital map. Where high quality digital maps are used, attempts are generally made to maintain and update the maps to accommodate changes that occur in the environment; however, the overhead associated with verifying and distributing map data to a fleet of autonomous vehicles can be substantial. Furthermore, even with rapid updates, changes may nonetheless arise suddenly in an environment and not be reflected in the map data used by autonomous vehicles operating in the environment, and it is generally desirable for an autonomous vehicle to identify when mapped data does not match the current environment, and to do so as early as possible, in order to allow the autonomous vehicle to respond appropriately to its current environment.

One particular situation that an autonomous vehicle may encounter is a road closure event, which may be considered herein to be an event that requires an autonomous vehicle to unexpectedly leave the roadway upon which it is currently operating. In implementations in which high quality digital maps are used in autonomous vehicle control, a road closure event may be considered to represent a type of map anomaly, as a roadway that is closed to traffic is inconsistent with a digital map that defines the roadway as a drivable region for the autonomous vehicle. Put another way, a map anomaly exists in such a situation because the digital map defines a drivable roadway that is in fact not currently drivable.

Some types of road closure events, for example, may be as a result of construction events, and may require, for example, all traffic, including the autonomous vehicle, to be routed off of a mapped region of the roadway. In some instances, for example, traffic may be diverted onto a previously-unmapped road surface (e.g., temporary pavement) formed adjacent to the mapped region of the roadway. In some instances, for example, as a result of road construction new pavement may be deposited adjacent to one of the shoulders of a roadway, e.g., within the median separating the region of the roadway from one or more opposite direction lanes that carry traffic in the opposite direction, adjacent the opposite shoulder and beyond the outside boundary of the roadway. In either instance, at least a portion of the new pavement is disposed outside of a mapped edge of the roadway, such that from the perspective of the map, the portion of the new pavement is considered to be in a non-drivable area of the environment.

In other instances, as a result of road construction traffic may be routed into one or more opposite direction lanes of the roadway. Consider, for example, a four lane north/south divided highway configured to carry two lanes of northbound traffic and two lanes of southbound traffic. It is not uncommon for a construction project needing to work on the northbound lanes to close those lanes to traffic, and then install temporary barriers between the two southbound lanes to essentially allow for a single lane of northbound traffic and a single lane of southbound traffic on the two normally-southbound lanes. Operation of an autonomous vehicle traveling in the northbound direction in the southbound lane, however, is generally prohibited, so from the perspective of the map, the southbound lane is also considered to be in a non-drivable area of the environment.

In still other instances, whether due to construction or emergency events such as vehicle crashes, flooding, fires, snow, etc., a roadway may be subject to a total roadway closure event where all traffic on the roadway is diverted off of the roadway and onto a connecting road (in the case of a roadway that has at-grade crossings) or exit ramp (in the case of a controlled-access roadway). From the perspective of the map, however, connecting roads or exit ramps may be considered to be different roadways when an autonomous vehicle has been routed to continue along a particular roadway, such that a total road closure event that diverts all traffic off of a roadway may be considered to force the autonomous vehicle to leave the roadway upon which it is operating.

An autonomous vehicle may be capable of detecting various aspects of a roadway, including, for example, various types of actual and logical boundaries on a roadway that constrain where the autonomous vehicle may travel and/or delineate acceptable lanes within which travel is permitted. Some boundaries may be physical in nature, including, for example, the physical edges of a roadway and/or various physical barriers along a roadway, including, for example, concrete barriers, guardrails, etc. that actually constrain where an autonomous vehicle may travel. In addition, some boundaries may not physically constrain a vehicle but may nonetheless logically delineate the acceptable lanes within which travel is permitted, e.g., painted or taped lines on the road surface the define the extent of each lane of travel, as well as delineate shoulders, exits, entrances, etc. Such logical boundaries may also present differing semantic constraints, e.g., dashed lines that separate adjacent same-direction lanes or that allow for passing, double solid lines that restrict lane changes or passing, etc.

In construction areas, these existing boundaries may also be supplemented by additional boundaries such as repainted or taped lines for temporary traffic diversions (which in some instances may overlap existing lines), spaced apart construction elements such as barrels or traffic cones that appear as distinct objects to the perception system, and construction elements such as jersey barriers that can be difficult to classify due to difficulties in determining object boundaries.

Detection of such boundaries, however, is generally range-limited, particularly in the presence of other vehicles that may occlude the roadway ahead of an autonomous vehicle. It has been found, however, that detection of other vehicles in the roadway, as well as their tracks or trajectories, can be performed at a comparatively greater range due to greater detectability in the camera, radar and LIDAR spaces. As such, in the illustrated implementations, the tracks of these other, non-ego vehicles may be used in the detection of map anomalies associated with road closure events.

In particular, in the illustrated implementations, observation data collected by one or more sensors of an autonomous (ego) vehicle and associated with one or more non-ego vehicles operating on the same roadway as the autonomous vehicle (also referred to herein as non-ego vehicle observation data) may be used to generate non-ego vehicle tracks for non-ego vehicles operating ahead of the autonomous vehicle in the roadway, and those tracks may be monitored to detect a roadway closure event as described above. The roadway closure event may be detected, for example, in response to detecting one or more of the non-ego vehicle tracks leaving the roadway upon which the autonomous vehicle is operating. Then, as described in greater detail below, the detection of a roadway closure event may be used to trigger a correction action in the autonomous vehicle prior to the autonomous vehicle arriving at a location at which the detected non-ego vehicle tracks leave the roadway.

In some environments, for example, it has been found that the tracks of non-ego vehicles can be detectable at a substantially greater range than can boundaries and other features on a roadway surface, even under ideal circumstances. Thus, in some implementations, detection of a track of a non-ego vehicle leaving a roadway may be performed at a range that is more than a boundary detection range of the sensors of the autonomous vehicle, i.e., the maximum range at which boundaries and other features on a roadway surface are generally detectable by the sensors of the autonomous vehicle. At a speed of 100 kph, for example, every 100 meters of added range results in about 3-4 seconds of additional reaction time, so it should be appreciated that the use of non-ego vehicle tracks can allow for earlier detection of road closure events, and additional time to initiate a corrective action, as would otherwise be expected based upon detection of boundaries and other features on a roadway surface.

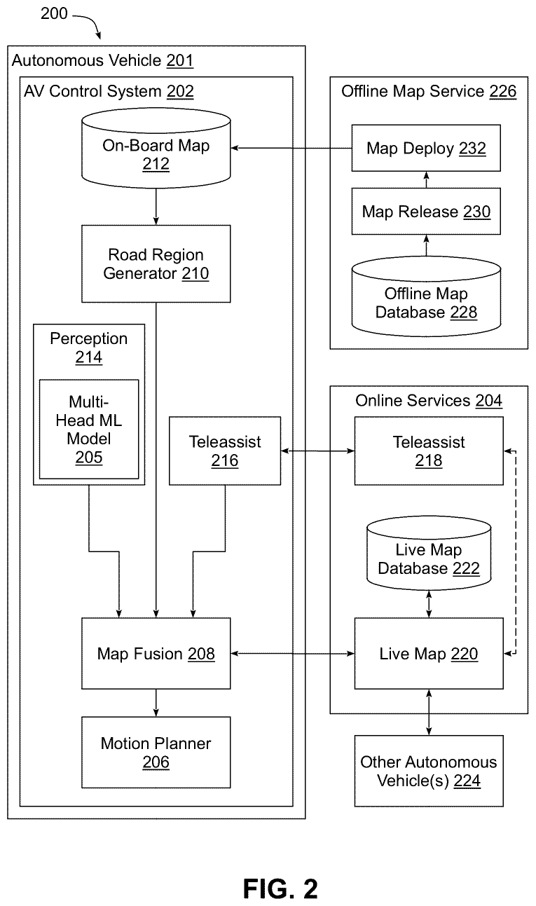

FIG. 2, for example, illustrates an example system 200 incorporating track based map anomaly detection consistent with some implementations of the invention. System 200 includes an autonomous vehicle 201 with an autonomous vehicle control system 202 in communication with a set of online services 204, and supporting a perception-based multi-head machine learning model 205 consistent with some implementations. As will become more apparent below, multi-head machine learning model 205 may be configured to detect non-ego vehicles, as well as other entities in the environment, e.g., dynamic and/or static objects and/or various actual and/or virtual boundaries. System 200 also supports both live map and teleassist functionality; however, in other implementations, one or both of live map functionality and teleassist functionality may be omitted.

Within autonomous vehicle 201, a motion planner component 206 receives data, e.g., an augmented road region layout, from a map fusion component 208. Map fusion component 208 may receive a digital map, e.g., a road region layout, from a road region generator component 210. Component 210 may generate a road region layout by accessing an on-board map 212 to retrieve offline map data suitable for generating a digital map of the environment surrounding autonomous vehicle 201 during operation. Map fusion component 208 may also receive observation data from a perception component 214, which collects observations using one or more sensors in the manner discussed above, and which in the illustrated implementation utilizes multi-head machine learning model 205. A perception component in some implementations may also provide tracks for various dynamic objects directly to motion planner component 206. Where teleassist support is provided, map fusion component 208 may also receive teleassist data, e.g., teleassist operator input, from a teleassist component 216 that is in communication with a remote teleassist system 218. Furthermore, in some implementations, map fusion component 208 may also receive additional observation data from a live map system 220, such that the data collected from components 210, 214, 216 and 220 may be fused into the augmented road region layout used by motion planner component 206 when generating a trajectory or path of motion for the autonomous vehicle.

The observation data provided by live map system 220 is stored in a live map database or data store 222, and includes observation data collected from one or more other autonomous vehicles 224. Live map system 220 is generally in bi-directional communication with both autonomous vehicle 201 and other autonomous vehicle(s) 224 to both collect observation data for autonomous vehicles 201, 224 and to propagate observation data collected by autonomous vehicles 201, 224 operating in a particular portion or region of the environment to other autonomous vehicles 201, 224 operating in the same portion or region of the environment. In addition, teleassist system 218 may also be in bi-directional communication with live map database 222 via live map system 220 to enable a teleassist operator to store teleassist data, e.g., location-based teleassist triggers, to be propagated to autonomous vehicles via live map system 220, as well as to retrieve observation data from live map database 222 in connection with conducting a teleassist session with autonomous vehicle 201. Teleassist system 218 may also be in bi-directional communication with autonomous vehicle 201 in some implementations (e.g., via teleassist component 216) to allow an autonomous vehicle to provide situational awareness data to a teleassist operator and to allow the teleassist operator to provide suggesting actions to the autonomous vehicle. In some implementations, no direct link may be present between teleassist system 218 and live map system 220, such that communication between these components may be handled through map fusion component 208 and teleassist component 216.

Live map system 220 and live map database 222 are representative of an online map system that propagates observation data within an autonomous vehicle fleet, as opposed to an offline map service 226, e.g., an atlas system or service, that provides offline map data to the autonomous vehicle fleet. An offline map service 226, for example, may include an offline map database 228 that maintains a global repository of offline map data. A map release component 230 may be used to generate versioned updates of the offline map database, and a map deploy component 232 may be used to deploy or propagate the database updates to an autonomous vehicle fleet. It will be appreciated that a global repository of offline map data may be substantial in size, so in some implementations only a portion of the offline map data corresponding to the particular area (e.g., a city, a state, a county, etc. within which autonomous vehicle 201 operates) may be deployed to the autonomous vehicle and maintained in its on-board map 212. In addition, based upon movement of the autonomous vehicle into adjacent areas, additional portions of the offline map data may be communicated to the autonomous vehicle by service 226 such that the on-board map 212 includes sufficient offline map data to operate the autonomous vehicle at its current location.

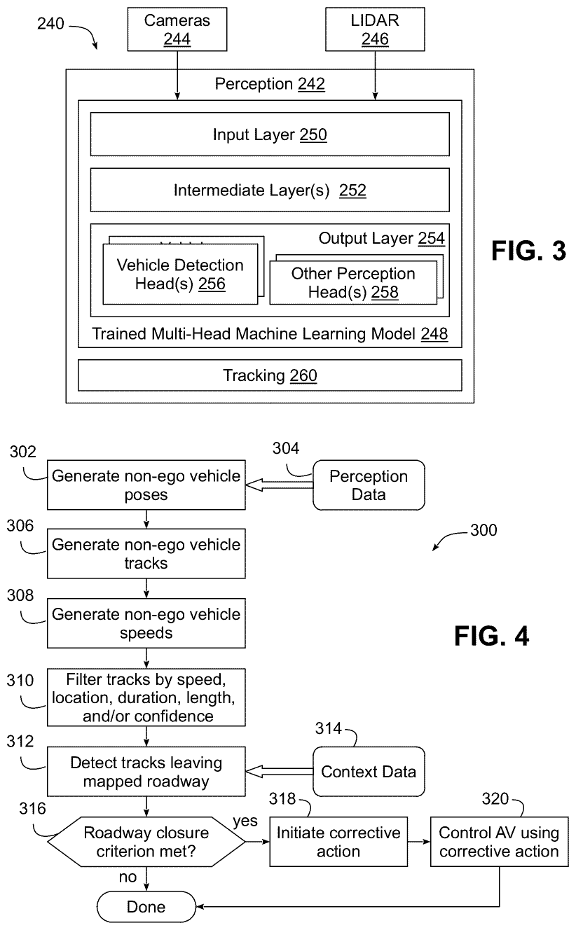

FIG. 3 next illustrates one example manner of implementing multi-head machine learning model 205 of FIG. 2. FIG. 3, in particular, illustrates an example autonomous vehicle control system 240 including a perception component 242 that receives as input perception data, e.g., as captured by one or more cameras or image sensors 244 (e.g., a camera with a forward-facing field of view) and LIDAR data, e.g., as captured by one or more LIDAR sensors 246. Each of image sensor 244 and LIDAR sensor 246 may be positioned on an autonomous vehicle to sense the roadway upon which the autonomous vehicle is disposed.

Perception component 242 includes a trained multi-head machine learning model 248 that is configured to, in part, generate a plurality of non-ego vehicle poses. Model 248 in particular integrates detection of non-ego vehicles with other types of perception functions, such as cyclist/pedestrian detection, road sign detection, obstacle detection, boundary detection, etc.

In some implementations, for example, trained multi-head machine learning model 248 may be implemented as a deep neural network (DNN) including an input layer 250, one or more intermediate layers 252, and an output layer 254 including one or more vehicle detection heads 256 and one or more other perception heads 258. In some implementations, for example, one or more intermediate layers 252 may include one or more convolutional layers. The dimensions/shape of input layer 250 may be dependent on the shape of the perception data to be applied, while the dimensions/shape of each output head 256, 258 may be dependent on various factors such as how many class probabilities are to be predicted, among others. In some implementations, multiple convolution layers may be provided, and max pooling and/or other layers such as affine layers, softmax layers and/or fully connected layers may optionally be interposed between one or more of the convolution layers and/or between a convolution layer and the output layer. Other implementations may not include any convolution layer and/or not include any max pooling layers, and in still other implementations, other machine learning models may be used, e.g., Bayesian models, random forest models, Markov models, etc.

In some implementations, model 248 may generate the following outputs: category (pedestrian, bicyclist, vehicle, emergency vehicle, sign, etc.) and the associated confidence; heading in the local frame and the associated uncertainty; position in the local frame and the associated uncertainty; extents, i.e., the length and width of the object represented as an oriented box and the associated uncertainty, and velocity/motion information and the associated uncertainty.

In addition, a tracking module 260 may include one or more trackers capable of generating tracks for the various detected objects over multiple frames. Trackers may render predictions of how existing tracks would appear in the sensor and then compare that rendering to incoming sensor data. When appropriate, the trackers may publish updates, which define a function that adjusts the track to better agree with the sensor data. Some of the trackers may also publish proposals for new tracks. The trackers may also be responsible for deleting tracks once they leave the sensors'field of vision (FOV) and are no longer perceived. In the illustrated implementation, for example, each tracker may take sensor data or the output of sensor data processing (“virtual” sensor data in the form of detections) as input, obtain existing tracks at the latest time before the time of the incoming measurements, associate relevant subsets of the sensor data or detections to the tracks, produce state updates for tracks with associated measurements, optionally generate proposals for new tracks from unassociated sensor data or detections, and publish updates and/or proposals for consumption by a track manager in the tracking module. In other implementations, some or all of the tracking may be integrated into model 248, rather than being implemented in a separate module.

In some implementations, multi-head machine learning model 248 may in part also implement a unified boundary machine learning model capable of detecting multiple types of boundaries. Moreover, by utilizing a multi-head machine learning model, reduced system-level computation and memory usage, as well as joint optimization of all functions as well as optimization of contextual interactions between different boundary/object types, may be provided. Model 248 in particular may integrate detection of perceived boundaries associated with a plurality of semantic boundary types for a roadway. A semantic boundary type, within the context of the disclosure, may be considered to refer to a particular classification of boundary within a schema of detectable boundary types. Boundary types in some implementations may be classified based upon whether they are physical or virtual (i.e., whether or not they represent a continuous physical barrier constraining autonomous vehicle movement), whether they are actual or logical (i.e., whether they represent actual physical objects in the environment that an autonomous vehicle should avoid or they represent a logical construct that, for example, for legal or regulatory reasons, they are required to obey), and/or based upon other classifications. For example, a physical barrier such as a guardrail, jersey barrier or permanent concrete barrier may be associated with a physical barrier semantic boundary type, and a painted or taped line on the surface of the roadway that forms the boundary of a lane may be associated with a painted lane semantic boundary type. Likewise, a road edge, e.g., at the boundary between the road and a curb, median, a gravel shoulder, or other non-drivable surface that delineates the edge of the drivable area of a roadway may be associated with a road edge semantic boundary type.

Still other boundary type classifications may be based, for example, upon whether they are permanent or temporary/construction in nature, and in some instances, boundary types may be classified with finer granularity, e.g., to distinguish between guardrails and concrete barriers, between different types of road edges, between different types of painted lane boundaries (e.g., yellow vs. white, single dashed, single solid, double solid, solid and dashed), etc.

In other implementations, however, detection of perceived boundaries may be implemented in other manners, e.g., external to perception component 242 or in one or more separate machine learning models from multi-head machine learning model 248. In addition, it will be appreciated that detection of non-ego vehicles and generation of tracks or pathways associated therewith, may be implemented in other manners, so the invention is not limited to the particular implementations discussed herein.

FIG. 4 next illustrates an example operational sequence 300 for detecting map anomalies associated with road closure events using non-ego vehicle tracks or trajectories, e.g., as may be implemented within autonomous vehicle control system 202 of FIG. 2. In block 302, observation data, e.g., as collected by one or more sensors (e.g., one or more of a LIDAR, camera, radar, etc.) of the autonomous vehicle (represented by perception data block 304), is used to generate non-ego vehicle poses for one or more non-ego vehicles in the geographical area within which the autonomous vehicle is operating. At least some of the non-ego vehicle poses are for non-ego vehicles operating ahead of the autonomous vehicle in the roadway. In some implementations, the generation of the non-ego poses may be performed by a multi-head machine learning model such as model 248 of FIG. 3.

Next, in block 306, non-ego vehicle tracks or trajectories are generated from the non-ego vehicle poses generated in block 302 (e.g., using a tracking component such as tracking module 260 of FIG. 3), and in some implementations (as illustrated by block 308) additional data regarding the non-ego vehicle tracks, e.g., speeds, may optionally be generated to provide additional context from which road closure events may be detected.

Thereafter, in block 310 the non-ego vehicle tracks may be filtered based on various criteria, e.g., speed, location, duration, length, and/or degree of confidence. In this regard, speed may refer to the speed of the vehicle represented by a non-ego vehicle track, while location may refer to the location of the track relative to the autonomous (ego) vehicle. It will be appreciated, for example, that tracks of vehicles that are behind the autonomous vehicle, are traveling in the opposite direction or on a different roadway, or are otherwise not ahead of the autonomous vehicle and traveling in the same direction, will not be relevant to detecting a road closure event ahead of the autonomous vehicle.

Duration may be considered to be the duration that a non-ego vehicle has been tracked, length may be considered to be the distance that a non-ego vehicle has been tracked, and degree of confidence may be considered to be an indication of how confident the autonomous vehicle control system is that a non-ego vehicle track accurately represents the trajectory of an actual non-ego vehicle in the environment. It will be appreciated, for example, that due to occlusion of sensors by other vehicles and/or objects along the roadway, non-ego vehicles may go in and out of the line of sight of a sensor over time, so filtering may therefore be used to focus road closure event detection on the most trustworthy tracks sensed by the autonomous vehicle sensors. In addition, some perception systems additionally output confidence levels associated with detected objects in the environment, representing how confident the perception system is that a detected object assigned to a particular category is correctly assigned. In one example highway implementation, for example, filtering may be used to filter out tracks of vehicles traveling below about 20 meters per second, tracks having a history of less than about 5 seconds, and tracks having a confidence below a predetermined threshold.

Next, in block 312, the remaining (unfiltered) tracks are analyzed to detect whether any of the tracks leave the mapped roadway. In some implementations, for example, tracks may be detected as leaving the mapped roadway when the trajectories of the tracks are determined to have crossed any mapped road edges for the roadway and continued in a region determined to be outside of the mapped extents of the roadway. In some implementations, additional context data (represented by context data block 314) may also be used when detecting tracks leaving the mapped roadway, e.g., to consider other aspects of the environment such as the presence of emergency vehicles, signs, lights, construction elements, etc. in the vicinity of the location where tracks have been detected crossing a mapped road edge of a roadway.

Block 316 next determines whether a road closure criterion has been met. For example, in some implementations, a road closure criterion may be based on the number of tracks determined to have left the roadway, the number of sensing intervals in which tracks have been determined to have left the roadway, or practically any other criteria that indicate the probability of a road closure event having occurred. If the road closure criterion has not been met, operational sequence 300 is complete. However, if the road closure criterion has been met, control instead passes to block 318 to initiate a corrective action, which in various implementations may include operations such as decreasing vehicle speed, initiating a lane change, initiating a safety stop, initiating a follow-the-leader mode (e.g., when the autonomous vehicle is operating in a caravan with multiple vehicles) and/or initiate a teleassist session). Then, in block 320, the autonomous vehicle is controlled or operated using the initiated corrective action(s) (e.g., by controlling any of the vehicle control systems discussed above in connection with FIG. 1), and operational sequence 300 is complete.

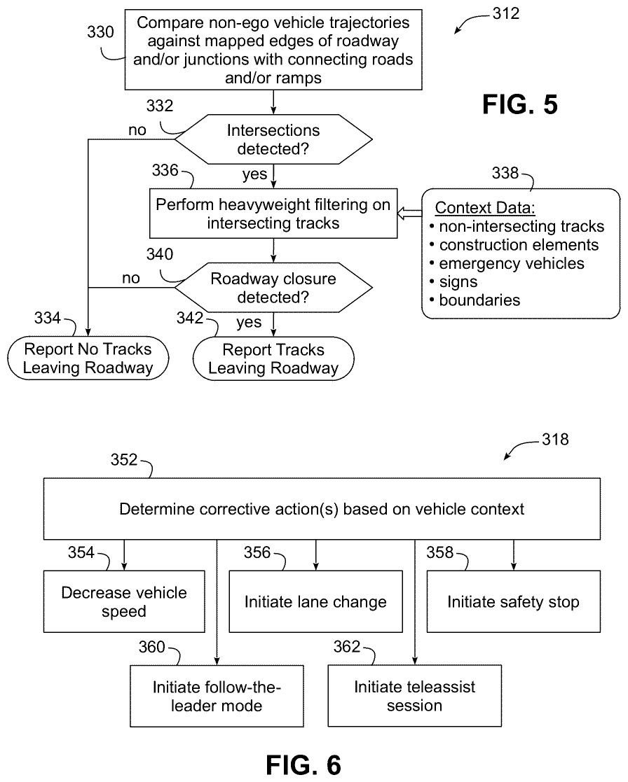

The manner in which tracks may be detected as leaving the roadway may vary in different implementations. FIG. 5, for example, illustrates one manner of implementing block 312 of FIG. 4, in which a multi-step analysis is performed to reduce computational overhead and improve computational efficiency. In block 330, the trajectories of the non-ego vehicle tracks are compared against the mapped edges of the roadway and/or mapped junctions with connecting roads and/or ramps to determine whether any trajectory intersects with those mapped edges and/or junctions. In this regard, a junction between a roadway and a ramp or connecting road may be considered to be an edge of the roadway in some implementations given that a vehicle, once it has entered the mapped region of the connecting road or ramp, is no longer considered to be traveling on the roadway.

Block 332 next determines whether any such intersections have been detected, and if no intersections have been detected, control passes to block 334 to report that no tracks have been detected as leaving the roadway. If, however, one or more intersections are detected, control instead passes to block 336 to perform more heavyweight filtering on the intersecting tracks to determine whether a road closure event has likely occurred, e.g., by analyzing in greater detail the positions of the intersecting tracks and comparing them to the stored map data for the roadway.

At this time, additional context data, represented by block 338, may also be considered. For example, it may also be desirable to analyze non-intersecting tracks, as a road closure event is generally not indicated when only some of the traffic is being routed off of the roadway. If a steady flow of tracks continue along the roadway, despite the fact that multiple tracks are found to be leaving the roadway, it is less likely that a road closure event has occurred. Likewise, it may also be desirable to consider other objects detected in the vicinity of the potential road closure event, e.g., the presence of construction elements such as barriers; emergency vehicles such as ambulances, police cars, fire trucks, etc. ; construction vehicles with flashing lights; signs; flashing lights; boundaries; etc., as such objects may or may not be indicative of a likely road closure event. If, for example, an electronic sign is detected blocking a portion of the roadway and displaying the text “Road Closed, Please Exit Now” was detected, that, in combination with multiple tracks detected leaving the roadway, would correlate with high probability to a road closure event. As another example, if it is determined that a vehicle track has left the roadway, the vehicle track may be analyzed to determine if the vehicle was previously on a relevant road segment, such that a vehicle driving in the opposite direction could be disregarded even if it was initially detected as having left the roadway.

As such, block 340 may determine, based on the results of block 336, whether a roadway closure has been detected. If so, control passes to block 342 to report that one or more tracks have been detected as leaving the roadway, and if not, control passes to block 334 to report that no tracks have been detected as leaving the roadway.

It will be appreciated that the comparison performed in block 330 may be implemented in a relatively lightweight, and relatively computationally efficient manner, given that each trajectory may be represented by a curvilinear path, e.g., a polyline, that may be compared against the mapped edges of the roadway using relatively lightweight geometric calculations. In contrast, block 336 may require relatively greater computational overhead. Thus, block 332 may effectively reduce the overall computational overhead associated with monitoring for road closure event-associated map anomalies, as the more computationally intensive operations performed in block 336 may be avoided when the preliminary analysis performed in block 330 fails to detect any intersections with the mapped edges of the roadway.

In addition, as noted above, the various corrective actions that may be performed in response to detection of a road closure event may vary in different implementations. FIG. 6, for example, illustrates one example implementation of block 318 of FIG. 4, in which block 352 determines one or more corrective actions based on the current vehicle's context, and initiates various corrective actions responsive thereto, including, for example, one or more of decreasing vehicle speed (block 354), initiating a lane change (block 356), initiating a safety stop (block 358), initiating a follow-the-leader mode (block 360) and/or initiating a teleassist session (block 362). It will be appreciated, in particular, that depending upon various factors, e.g., the current speed of the autonomous vehicle, the distance to the location of the road closure event, the presence of construction elements and/or other vehicles, etc., different corrective actions may be more appropriate in different situations. Where, for example, a substantial distance remains to the location of the road closure event and the autonomous vehicle is driving on a divided highway with light traffic, it may be sufficient to reduce the speed and/or change lanes to an outer (non-passing) lane, and it may not even be necessary to initiate a teleassist session. In contrast, where traffic is heavy and/or slowed or stopped, it may be desirable to initiate a teleassist session as quickly as feasible to receive assistance from a teleassist operator to navigate through the scenario, and in some instances, initiate a safety stop to direct the autonomous vehicle to the shoulder and come to a stop. In addition, in situations where the autonomous vehicle is operating in a caravan (e.g., as may be the case for semi-trucks) behind another vehicle in the caravan (which may be autonomous or non-autonomous), it may be desirable to transition the autonomous vehicle to a “follow-the-leader” mode whereby the autonomous vehicle operates by following the trajectory of a leader vehicle.

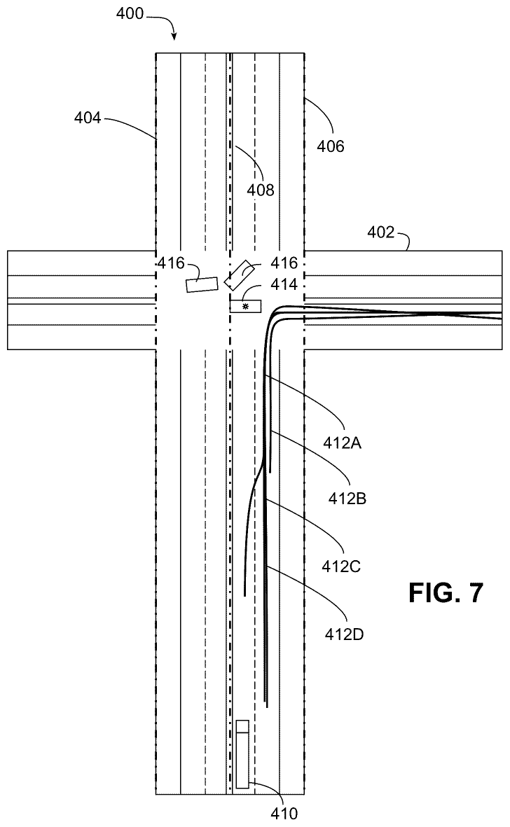

FIGS. 7-9 next illustrate various roadways subjected to potential road closure events. FIG. 7, for example, illustrates a roadway 400 with an example road closure event in which traffic is diverted onto a connecting road 402. In this example, roadway 400 is a four lane non-divided highway that intersects with a two lane connecting road 402, and from the perspective of the mapping system, has mapped road edges 404, 406 defined between the edges of the shoulders and the non-drivable region adjacent to the roadway. In addition, a road edge 408 may also be defined between the northbound and southbound lanes, as from the perspective of northbound traffic, and in particular autonomous vehicle 410, the southbound lanes are not considered drivable.

In this example, an accident has caused a complete road closure of roadway 400, as well as routing of traffic onto connecting road 402. This may be detected by autonomous vehicle 410 by generating tracks, e.g., tracks 412A-412D, for other vehicles ahead of the autonomous vehicle. It may be seen, in particular, that all of the tracks intersect mapped road edge 406 of roadway 400 and effectively leave roadway 400, and as such, the tracks may be used to indicate a roadway closure event to trigger the initiation of a corrective action. In addition, in some implementations, additional context data may be used in the determination of the roadway closure event, e.g., the detection of an emergency vehicle 414 with flashing lights and/or one or more stopped vehicles 416 in the roadway.

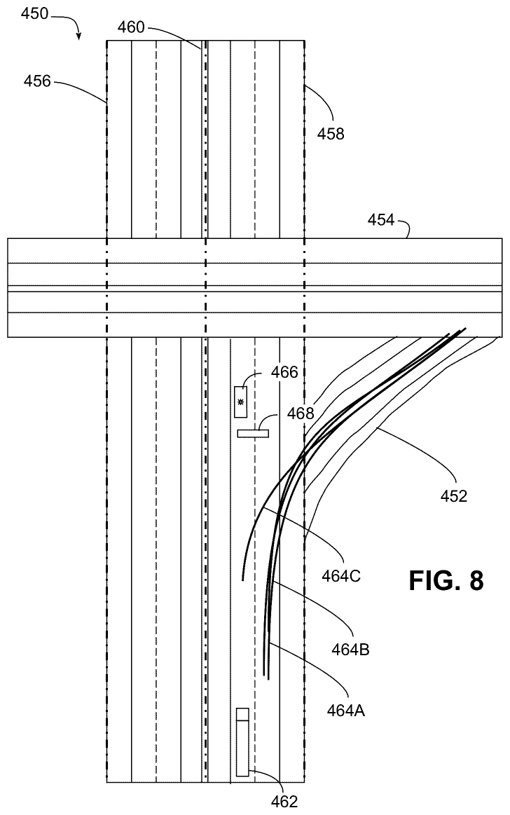

FIG. 8 illustrates a roadway 450 with an example road closure event in which traffic is diverted onto an exit ramp 452. In this example, roadway 450 is a four lane divided highway that passes under a two lane road 454 connected by exit ramp 452, and from the perspective of the mapping system, has mapped road edges 456, 458 defined between the edges of the shoulders and the non-drivable region adjacent to the roadway. In addition, a road edge 460 may also be defined between the northbound and southbound lanes (e.g., based on the presence of a median or concrete barrier).

In this example, overnight construction has caused a complete road closure of roadway 450, as well as routing of traffic onto exit ramp 452. This may be detected by autonomous vehicle 462 by generating tracks, e.g., tracks 464A-464C, for other vehicles ahead of the autonomous vehicle. It may be seen, in particular, that all of the tracks intersect mapped road edge 458 of roadway 450 and effectively leave roadway 450, and as such, the tracks may be used to indicate a roadway closure event to trigger the initiation of a corrective action. In addition, in some implementations, additional context data may be used in the determination of the roadway closure event, e.g., the detection of a construction vehicle 466 with flashing lights and/or one or more signs or construction elements 468 in the roadway.

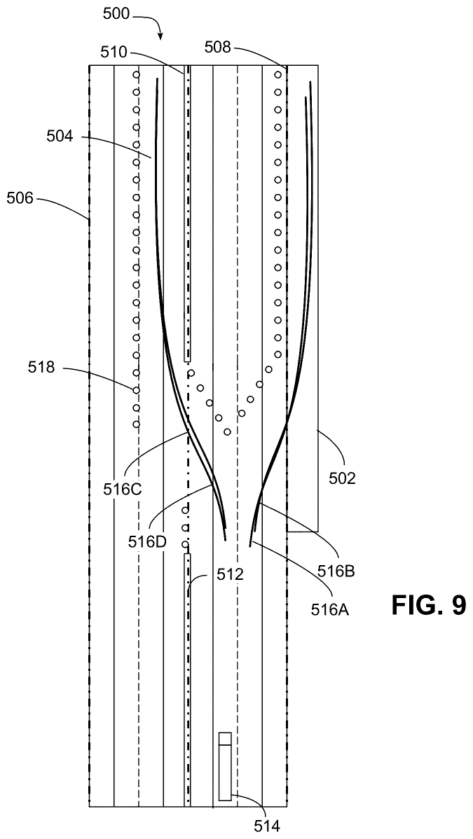

FIG. 9 illustrates a roadway 500 with an example road closure event in which traffic is diverted both onto an unmapped road surface 502, as well as into an opposite direction lane 504. In this example, roadway 500 is a four lane divided highway, and from the perspective of the mapping system, has mapped road edges 506, 508 defined between the edges of the shoulders and the non-drivable region adjacent to the roadway. In addition, a road edge 510 may also be defined between the northbound and southbound lanes (e.g., based on the presence of a median or concrete barrier 512).

In this example, construction has caused a complete road closure of roadway 500, as well as routing of the right northbound lane traffic onto temporary pavement 502 adjacent the shoulder of the northbound lanes, and routing of the left northbound lane traffic onto opposite direction lane 504 through a break in barrier 512. This may be detected by autonomous vehicle 514 by generating tracks, e.g., tracks 516A-516D, for other vehicles ahead of the autonomous vehicle. It may be seen, in particular, that all of the tracks from the right lane intersect mapped road edge 508 of roadway 500 and effectively leave roadway 500, while all of the tracks from the left lane intersect mapped road edge 510 and effectively leave the drivable region of roadway 500, the tracks may be used to indicate a roadway closure event to trigger the initiation of a corrective action. In addition, in some implementations, additional context data may be used in the determination of the roadway closure event, e.g., the detection of one or more signs or construction elements (e.g., barrels 518 in the roadway).

It will be appreciated that, while certain features may be discussed herein in connection with certain implementations and/or in connection with certain figures, unless expressly stated to the contrary, such features generally may be incorporated into any of the implementations discussed and illustrated herein. Moreover, features that are disclosed as being combined in some implementations may generally be implemented separately in other implementations, and features that are disclosed as being implemented separately in some implementations may be combined in other implementations, so the fact that a particular feature is discussed in the context of one implementation but not another should not be construed as an admission that those two implementations are mutually exclusive of one another. Other variations will be apparent to those of ordinary skill. Therefore, the invention lies in the claims hereinafter appended.

What is claimed is:

1. A method of controlling an autonomous vehicle, comprising:
receiving observation data collected from a geographical area by one or more sensors of the autonomous vehicle while the autonomous vehicle operates on a roadway in the geographical area, wherein the received observation data includes non-ego vehicle observation data for a plurality of non-ego vehicles operating ahead of the autonomous vehicle on the roadway and sensed by the one or more sensors of the autonomous vehicle;
generating a plurality of non-ego vehicle tracks using the non-ego vehicle observation data;
detecting a roadway closure event ahead of the autonomous vehicle on the roadway using the plurality of non-ego vehicle tracks, including determining that one or more of the plurality of non-ego vehicle tracks leave the roadway; and
in response to detecting the roadway closure event, initiating a corrective action in the autonomous vehicle prior to the autonomous vehicle arriving at a location at which the one or more non-ego vehicle tracks leave the roadway.

2. The method of claim 1, wherein the roadway closure event is a construction event associated with routing traffic off of a mapped region of the roadway.

3. The method of claim 2, wherein the construction event is associated with routing traffic off of the mapped region of the roadway and onto an unmapped road surface formed adjacent to the mapped region of the roadway.

4. The method of claim 1, wherein the roadway closure event is a construction event associated with routing traffic onto one or more opposite direction lanes defined in a mapped region of the roadway.

5. The method of claim 1, wherein the roadway closure event is a total roadway closure event associated with routing traffic off of the roadway and onto a connecting road or exit ramp.

6. The method of claim 1, wherein the corrective action includes decreasing a speed of the autonomous vehicle, initiating a session with a remote teleassist system, initiating a lane change to locate the autonomous vehicle adjacent to a shoulder of the roadway, initiating a follow-the-leader mode for the autonomous vehicle, or initiating a safety stop operation for the autonomous vehicle.

7. The method of claim 1, further comprising detecting, from the observation data, one or more signs, construction elements, construction vehicles, and/or emergency vehicles, wherein detecting the roadway closure event ahead of the autonomous vehicle on the roadway further uses the detected one or more signs, construction elements, construction vehicles, and/or emergency vehicles.

8. The method of claim 1, further comprising filtering the plurality of non-ego vehicle tracks based on one or more of a speed, a location, a duration, a length, and a confidence associated with the plurality of non-ego vehicle tracks.

9. The method of claim 1, wherein determining that the one or more of the plurality of non-ego vehicle tracks leave the roadway includes determining that trajectories of the one or more non-ego vehicle tracks intersect with mapped edges of the roadway.

10. The method of claim 1, wherein determining that the one or more non-ego vehicle tracks leave the roadway includes:
in a first, less intensive computational analysis step, determining that a first non-ego vehicle track of the one or more non-ego vehicle tracks intersects with a mapped edge of the roadway; and
after determining that the trajectory of the first non-ego vehicle track intersects with the mapped edge of the roadway, performing a second, more intensive computational analysis step on the first non-ego vehicle track to confirm that the first non-ego vehicle track leaves the roadway.

11. The method of claim 1, wherein determining that the one or more non-ego vehicle tracks leave the roadway includes determining that a non-ego vehicle track leaves the roadway by more than a boundary detection range ahead of the autonomous vehicle.

12. An autonomous vehicle control system for an autonomous vehicle, comprising:
one or more processors; and
memory storing instructions that, when executed by the one or more processors, cause the autonomous vehicle control system to:
receive observation data collected from a geographical area by one or more sensors of the autonomous vehicle while the autonomous vehicle operates on a roadway in the geographical area, wherein the received observation data includes non-ego vehicle observation data for a plurality of non-ego vehicles operating ahead of the autonomous vehicle on the roadway and sensed by the one or more sensors of the autonomous vehicle;
generate a plurality of non-ego vehicle tracks using the non-ego vehicle observation data;
detect a roadway closure event ahead of the autonomous vehicle on the roadway using the plurality of non-ego vehicle tracks, including determining that one or more of the plurality of non-ego vehicle tracks leave the roadway; and
in response to detecting the roadway closure event, initiate a corrective action in the autonomous vehicle prior to the autonomous vehicle arriving at a location at which the one or more non-ego vehicle tracks leave the roadway.

13. The autonomous vehicle control system of claim 12, wherein the roadway closure event is a construction event associated with routing traffic off of a mapped region of the roadway, a construction event associated with routing traffic onto one or more opposite direction lanes defined in a mapped region of the roadway, or a total roadway closure event associated with routing traffic off of the roadway and onto a connecting road or exit ramp.

14. The autonomous vehicle control system of claim 12, wherein the corrective action includes decreasing a speed of the autonomous vehicle, initiating a session with a remote teleassist system, initiating a lane change to locate the autonomous vehicle adjacent to a shoulder of the roadway, initiating a follow-the-leader mode for the autonomous vehicle, or initiating a safety stop operation for the autonomous vehicle.

15. The autonomous vehicle control system of claim 12, wherein the one or more processors are further configured to detect, from the observation data, one or more signs, construction elements, construction vehicles, and/or emergency vehicles, and to detect the roadway closure event ahead of the autonomous vehicle on the roadway by further using the detected one or more signs, construction elements, construction vehicles, and/or emergency vehicles.

16. The autonomous vehicle control system of claim 12, wherein the one or more processors are further configured to filter the plurality of non-ego vehicle tracks based on one or more of a speed, a location, a duration, a length, and a confidence associated with the plurality of non-ego vehicle tracks.

17. The autonomous vehicle control system of claim 12, wherein the one or more processors are configured to determine that one or more of the plurality of non-ego vehicle tracks leave the roadway by determining that trajectories of the one or more non-ego vehicle tracks intersect with mapped edges of the roadway.

18. The autonomous vehicle control system of claim 12, wherein the one or more processors are configured to determine that the one or more non-ego vehicle tracks leave the roadway by:
in a first, less intensive computational analysis step, determining that a first non-ego vehicle track of the one or more non-ego vehicle tracks intersects with a mapped edge of the roadway; and
after determining that the trajectory of the first non-ego vehicle track intersects with the mapped edge of the roadway, performing a second, more intensive computational analysis step on the first non-ego vehicle track to confirm that the first non-ego vehicle track leaves the roadway.

19. The autonomous vehicle control system of claim 12, wherein the one or more processors are configured to determine that the one or more non-ego vehicle tracks leave the roadway by determining that a non-ego vehicle track leaves the roadway by more than a boundary detection range ahead of the autonomous vehicle.

20. A non-transitory computer readable storage medium storing computer instructions executable by one or more processors to perform a method of operating an autonomous vehicle, the method comprising:
receiving observation data collected from a geographical area by one or more sensors of the autonomous vehicle while the autonomous vehicle operates on a roadway in the geographical area, wherein the received observation data includes non-ego vehicle observation data for a plurality of non-ego vehicles operating ahead of the autonomous vehicle on the roadway and sensed by the one or more sensors of the autonomous vehicle;
generating a plurality of non-ego vehicle tracks using the non-ego vehicle observation data;
detecting a roadway closure event ahead of the autonomous vehicle on the roadway using the plurality of non-ego vehicle tracks, including determining that one or more of the plurality of non-ego vehicle tracks leave the roadway; and
in response to detecting the roadway closure event, initiating a corrective action in the autonomous vehicle prior to the autonomous vehicle arriving at a location at which the one or more non-ego vehicle track leaves the roadway.
